(19) United States
(12) Patent Application Publication
(10) Pub. No.: US 2008/0091588 A1
(43) Pub. Date: Apr. 17, 2008

(54) Financial products and methods relating thereto

(76) Inventors: Barry Clare, London (GB); David Karat, London (GB); Mike Williamson, London (GB)

Correspondence Address: CASTELLANO PLLC, P.O. Box 1555, Great Falls, VA, 22066, US

(21) Appl. No.: 11/548,836

(22) Filed: Oct. 12, 2006

(51) Int. Cl. G06Q 40/00

(52) U.S. Cl. 705/38

(57) ABSTRACT

The invention provides a financial product and methods and systems relating thereto for providing access by a borrower to an underlying investment in an employer firm or related entity as an adjunct to the borrower's employment such that repayment of the financial product includes the payment of a pre-determined share of the borrower's upside in the underlying investment upon a realization event. The invention also provides systems and methods for providing, calculating, qualifying and determining parameters of said financial products.

### BACKGROUND OF THE INVENTION

1. Field of the Invention

The present invention relates generally to financial products offered to borrowers to facilitate investment in an underlying investment in an employer firm or related entity as an adjunct to the borrower's employment, wherein repayment of said financial products are conditioned with an upside repayment component that correlates to said borrower's upside on the underlying investment. The present invention also relates to systems and methods for creating, qualifying, and providing said financial products.

2. Background of the Invention

Within the financial community and business world, employer firms often provide qualified individuals, such as members, managers, corporate personnel or others, with the right and/or requirement to participate in an investment in the employer firm or related entity as an adjunct to employment. The right to participate in an underlying investment is often provided on a price or value privileged basis. In many cases, however, qualified individuals do not have the necessary means to participate in the underlying investments. In certain cases, qualified individuals may even be required to produce equity for investment in an employer firm as a condition of employment.

Investments of this sort are, in most cases, illiquid and unlisted. While participation by the borrower may occur on a price or value privileged bases, substantial obstacles may impede participation by a qualified individual. The illiquid nature of the investment is often a function of the fact that the underlying investment in an employer firm or related entity is with a private, i.e. non-publicly traded, company. The investment may, also be illiquid, where for example, there are conditions or limitations on the transfer, sale, or other disposition of the investment. Thus, the marketable value of the investments may not be easily determined, and realization of returns by the qualified individual may be difficult.

One such example in which an employer firm may provide a qualified individual with the right to participate in an underlying investment on a price or privileged basis is the leveraged buyout transaction. In a leveraged buyout transaction, or LBO, purchasers of a company make an acquisition using significant amounts of borrowed money to meet the cost of purchase. In this manner, purchasers may make large acquisitions without the need to commit large amounts of their own capital. In some instances, the company's assets secure the debt and typically repayment terms attendant to the debt require payment of a percentage of the debt within a few years, often times utilizing the newly formed company's cash flow for debt repayment.

A typical LBO may be characterized by a purchase that is funded with 70% debt and 30% equity or quasi-equity, although, one of skill in the art would understand that such a ratio does vary. And because of the ability to use highly leveraged financing to make acquisitions, participants in LBO's are capable of realizing large returns on equity. In other words, any increase in value of the company disproportionately affects the equity portion of the new company's owners, and hence, provides a greater return on a percentage basis with respect to that equity portion. This structure allows LBO participants to realize greater returns than in other financial areas, deals, or investments.

Typically, LBO transactions are conducted by private equity firms or enterprises that arrange and structure the financing. LBO transactions can vary in size in that existing companies of various valuations may be purchased. Private equity firms typically arrange highly leveraged financings, using only a small amount of equity as compared to the full cost of acquisition, to purchase the existing company. Upon purchase, managers are installed and the company is run with a view of increasing the company's value. In many instances, existing managers or other qualified employees or potential employees may participate (i.e., invest) in the LBO transaction.

Participation by qualified personnel in an underlying investment in the employer firm serves to align interests between employees and the other investors. By allowing a manager to participate in the leveraged buyout transaction, a manager's investment is aligned with other investors in the new company. Alignment of interests in this manner is thought to increase the incentive of managers of a new company to create value and wealth from the new company. In most cases, the managers may invest on a price or value privileged basis.

Private equity firms or other enterprises participating in LBO transactions have established means and methods of securing financing and capital for the LBO transactions. For example, the private equity firm participating in an LBO may have raised capital and financing commitments from various investors or other financial institutions Thus, private equity firms are readily capable of committing to the transaction requirements for LBO transactions.

On the other hand, managers or other qualified personnel typically do not have access to the types of capital or other financing to fund investments in LBO transactions. In rare circumstances, a manager may have sufficient personal capital to meet his or her investment requirements in an LBO transaction. More often than not, however, a manager is required to find financing. Only a limited range of different sources for a manager's capital investment in an LBO transaction exist, and said financing is typically restrictive and difficult to obtain.

For example, a manager may access equity in a personal asset, such as their home, to raise the equity for investment in an LBO transactions. In this example, a number of drawbacks are readily apparent: managers expose personal assets to risk, co-signing may be required, the managers' future financial flexibility is reduced. etc.

Limitations to raising the required equity for a manager's investment in an LBO transaction also impact the ability of a manager to participate in said transaction. For example, a managers'0 capital or access to financing may be tied up in other investments or financial commitments that do not permit the reallocation of a manager's financial resources to a new investment, regardless of how enticing the new investment may be. Thus, managers may have to forgo investment opportunities in LBO transactions simply because the timing is inconvenient or other circumstances limit a manager's ability to raise sufficient investment capital. These lost opportunities not only impact the financial gains potentially available to managers and members, but also impact private equity firms or other investor participants where the potential managers and members are deemed important, critical, or otherwise preferable participants as managers or members of a new company formed by an LBO transaction.

Finally, the first 100 days of an LBO transaction is traditionally deemed important to the success of the LBO transaction. During this period, due diligence, deal completion and other business considerations are paramount and an distractions from these important aspects of an LBO transaction can negatively impact the success of the new company. Because of this as well as other factors known to those of skill, in the art, the current financial products available to managers of LBO transactions are not optimal, inefficient, and potentially impair the success of the LBO transaction and new company formed therefrom.

Another example of qualified individuals participating in financial transactions with an employer firm that may have access to investments on a price or value privileged basis occurs with members of equity firms. In this example, members of equity firms may be required to personally participate in by investing in a deal, whether an LBO transaction or other transaction, or a fund in respectively sponsored or managed by the relevant private equity firm. In these instances members of private equity firms are expected to contribute funds for a portion of the purchase price or fund commitment as the case may be. For example, private equity firms may arrange for the leveraged buyout of an existing enterprise. In some cases, a private equity firm may arrange financing for the transaction from an investment fund. As a condition of the financing, members of the private equity firm may, be required to participate, at least in part, in either the fund that is financing the transaction or make a direct equity contribution to the deal. As is the case with managers and other qualified personnel, members may be required to secure loans using personal assets as collateral or spend a significant portion of their personal capital to participate in the transaction. Thus, members may similarly be prevented from participating in the investment given known and practiced lending methods.

Because of the ability to participate in the underlying investment of an employer firm on a price or privileged basis, such investments are often deemed particularly attractive to those who may participate. On the other hand, investments of these type are illiquid often unlisted, and may carry high risk. In part, because of these factors, traditional loan products and methods thereof for financing underlying investments in employer firms by a borrower as an adjunct to employment do not exist, which in turn can impede deal flow and/or prevent investment. Accordingly, new financial products and systems and methods for qualified personnel are needed.

### SUMMARY OF THE INVENTION

In one embodiment of the present invention, a primary financial product is provided wherein said primary financial product provides a Borrower with access to participation in an underlying investment in an employer firm or related entity (such as a fund). The primary financial product is conditioned on the repayment to the Finance Provider of a principal, interest, and a pre-determined share in the Borrower's upside in the underlying investment upon a realization event.

In another embodiment of the present invention, a method of facilitating a Borrower's participation in an underlying investment in an employer firm is provided wherein the method comprises offering one or more Borrowers a primary financial product that conditions repayment of the primary financial product with an upside payment component. The upside payment component correlates to a percentage of a Borrower's upside in the underlying investment in an employer firm or related entity.

In another embodiment of the present invention, a system for offering a primary financial product is provided comprising a computer system configured with at least one database, at least one client workstation, and programmable instructions, said system configured to execute a qualification step, valuation step, and calculation step. The system is further configured to determine the availability and terms of said primary financial product to a Borrower where said Borrower is participating in an underlying investment in an employer firm or related entity. In this embodiment, the primary financial product comprises an upside repayment component where the upside repayment component reflects a percentage of a Borrower's upside in the underlying investment. The system is further configured to perform the qualification step, valuation step, and calculation step based on user input relating to a leveraged buy out transaction or Borrower data or both.

In another embodiment of the present invention, a secondary financial product comprised of a collection of primary financial products is provided as an investment vehicle to investors.

### BRIEF DESCRIPTION OF THE DRAWINGS

The present invention can be more fully understood by reading the following detailed description together with the accompanying drawings, in which the like reference indicators are used to designate like elements, and in which:

FIG. 1 is an exemplary schematic illustration of the structure of relationships of an embodiment of the present invention;

FIG. 2 is an exemplary schematic illustration of the stricture of relationships of an embodiment of the present invention;

FIG. 3 is an exemplary schematic illustration of the structure of relationships of an embodiment of the present invention;

FIG. 4 is an illustration of a primary financial product and the repayment component calculation upon a realization event in one embodiment of the present invention;

FIG. 5 is an illustration of historical IRRs to external investors in leveraged buyout transactions;

FIG. 6 is an illustration of an exemplary embodiment of the present invention; and

FIG. 7 is an illustration of an exemplary embodiment of the present invention.

### DETAILED DESCRIPTION

Hereinafter, aspects of a financial product, investment vehicle, and methods and systems thereof in accordance with various embodiments of the invention will be described. As used herein, any term in the singular may be interpreted to be in the plural and alternatively, any term in the plural may be interpreted to be in the singular. The systems and methods of the invention are direct to the above stated problems as well as other problems, that are present in conventional techniques.

As used herein, a “Borrower” refers to any qualified individual who is offered participation in an underlying, investment in a firm or employer firm or related entity on a price or value privileged basis In other uses, qualified individual may be a borrower and may refer to an employee of a firm, enterprise, or other company, that is the subject of a leveraged buyout or other firm enterprise, or company that allows investment in the employer firm or related entity on a price or value privileged basis. In some instances, Borrower and qualified individual may also refer to a member or employee of a private equity firm that requires or offers participation in a financial transaction, wherein said participation refers to the right to invest in a firm or fund on a price or value privileged basis. Additionally, Borrower may refer to a fund or other investment vehicle that may participate in investments in an employer firm or related entity on a price or value privileged bases. In the case of an investment in a leveraged buy-out transaction, the privileged basis of the investment normally results from the “envy ratio” (see definition below) In the case of an investment in a fund, the privileged basis of the investment normally results from the Borrower's related right to share in the “carried interest” (see definition below) in the private equity firm of which he or she is an employee or member,

As used herein, a “Finance Provider” refers to an entity firm or other company that provides lends, finances, guarantees, purchases a subordination or otherwise facilitates the financing by a Lender of Record to a Borrower. Alternatively a Finance Provider may directly participate in the financing of a Borrower's underlying investment in an employer firm or related entity. Finance Provider may also, in some embodiments, be referred to as the Guarantor. As used herein, “Guarantor” is the entity, firm, or other company that agrees to repay a Lender of Record all or part of the principal and interest of a loan on behalf of a Borrower in the event that the Borrower fails to make the payments as required by the loan agreement.

As used herein, a “Financial Sponsor” refers to an entity, final, fund or collection of individuals that act as primary investors in a financial transaction, whether the transaction is a leveraged buyout transaction, merger, acquisition, or other financial investment or transaction. Financial Sponsor may be a combination of a private equity firm or fund and individual investors or some other combination of entities. Financial Sponsors differ from Borrowers in that Borrowers typically have a personal investment component directly related to the employer firm or related entity.

As used herein, “Loan to Value” or “LTV” refers to the ratio or percentage that a loan, guarantee, or other participation by the Finance Provider represents as it compares to the total participation by a Borrower in an underlying investment in an employer firm or related entity.

As used herein, “collateral” refers to the property or other rights used to secure financing by the Finance Provider in a financial transaction.

As used herein, “obligation” refers to the rights and responsibilities of a Borrower to repay the financing provided by the Finance provider.

As used herein, “interest rate” refers to the rate of interest that is charged on the loan amount, which is provided by the Finance Provider.

As used herein, “equity participation” refers to the pre-determined share, by the Finance Provider, in a realization event by the Borrower on a Borrower's equity or right to equity, of the company, firm, or other entity.

As used herein, “transaction specific risk factors” refers to one or more parameters used to measure the quality, stability, strength, risk, or other characteristic of a proposed financing, event in a firm or fund. Transaction specific risk factors may include, but are not limited to LTV, credit score, envy ratio, identity of sponsor, general marketplace conditions, marketplace sector, company or firm history or management ratings.

As used herein, “envy ratio” refers to the ratio between the effective price paid by management and that paid by the investing institution for their respective holdings of ordinary shares in an employer firm or related entity taking account of any amounts paid in respect of a related investment in preference shares, shareholder loan or equivalent The envy ratio may be expressed by the formula E=(IC/I %):(MC/M %), where “E” is the envy ratio, “IC” is the amount invested by the investors, “I %” is the investors' ownership of ordinary shares in the new company, “MC” is the amount invested by the managers, and “MC %” is the percentage of ownership of ordinary shares in the new company by the managers (i.e., the percentage of ordinary shares owned). Similarly “carried interest” refers to the right of a private equity firm to share in the gains made on realization of investments in leveraged buy-out transactions or other financial investments made by a private equity fund managed by that firm.

As used herein, the “internal rate of return” or “IRR” refers to the rate compounded annually at which the start value must grow to achieve a given end value.

As used herein, “base case” refers to the expected or predicted return on a single or pooled group of investments wherein the variables attendant thereto are fixed at an estimated value.

As used herein, “upside” refers to a realization or other value-adding event that is experienced by a participant in an underlying investment. Upside may refer to any beneficial interest secured by a qualified individual as a result of a financial transaction in which participation in the underlying transaction occurs on a price or value privileged basis. As used herein, upside generally refers to non-compensation realizations in an underlying investment such as a beneficial interest (i.e., right to receive income at a later date), carry (i.e. the net financing cost or difference between the cost of financing the purchase of an asset and the asset's cash yield), bonus, shares, options, or other non-salary realizations in value on an underlying investment. In one example, upside may refer to the increase in value in a manager's equity share in a company realized by an investor as a result of participation in a leveraged buyout transaction. Upside may also refer to the payment of non-salary compensation in the form of a bonus to a participant in a leveraged buyout transaction. Upside may also refer to the grant or receipt of returns related to a manager or member's participation in a firm, where such participation occurred as an adjunct to employment or financing such as a leveraged buyout transaction.

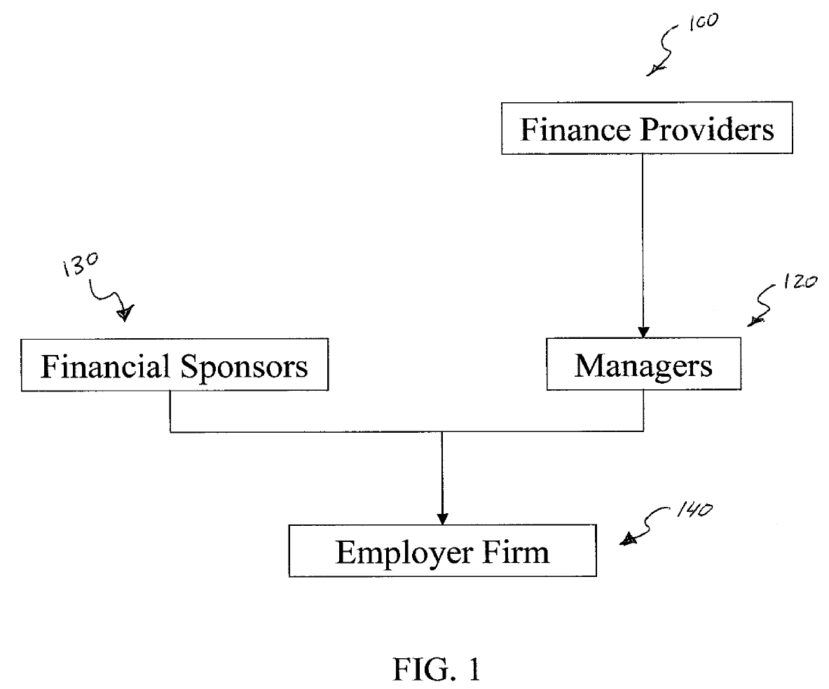

FIG. 1 is a high level overview of the structure of relationships between participants in one embodiment of the methods and systems of the present invention. As seen in FIG. 1, Finance Provider 100 provides financing to Managers 120 participating in an underlying investment in an employer firm. Managers 120, in conjunction with Financial Sponsors 130, participate in a financial transaction, such as an LBO, with the employer firm 140. In this example Finance Provider facilitates the financial transaction by directly providing financing to managers 120 participating the financial transaction and the manager's right to participate in an underlying investment in employer firm 140 occurs as an adjunct to employment.

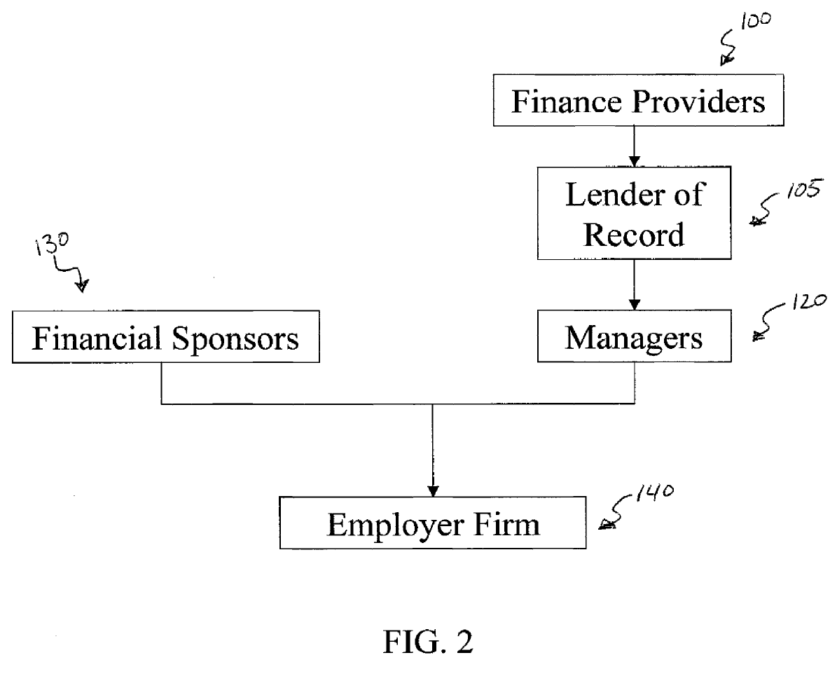

With reference to FIG. 2, an alternative embodiment is shown in which the financial transaction is a leveraged buyout transaction. As seen in FIG. 2, the Finance Provider 100 provides a Lender of Record 105 with a guarantee on money loaned by the Lender of Record to managers 120. As an adjunct to employment in the employer firm 140, managers 120 may participate in an underlying investment in employer firm 140. In this embodiment, Finance Provider 100 facilitates the LBO transaction 140 by guaranteeing the financing provided to managers 120 by Lender of Record 105.

In alternative embodiments, Finance Provider may facilitate financing by any number of known or conventional methods either directly to managers or through one or more intermediaries, including but not limited to Lenders of Record. As one of skill in the art would understand, the precise relationship between the parties is not critical to the practice of, and creation of, the present invention. Additionally, the financial transactions in which a qualified individual may participate in an underlying investment in an employer firm or related entity is not limited to leveraged buyout transactions. As one of skill in the art would understand, any transaction in which an employee, consultant, or other qualified individual may participate in an underlying investment in an employer firm or related entity as an adjunct to employment on a price or value privileged basis benefits from the products, systems and methods disclosed herein.

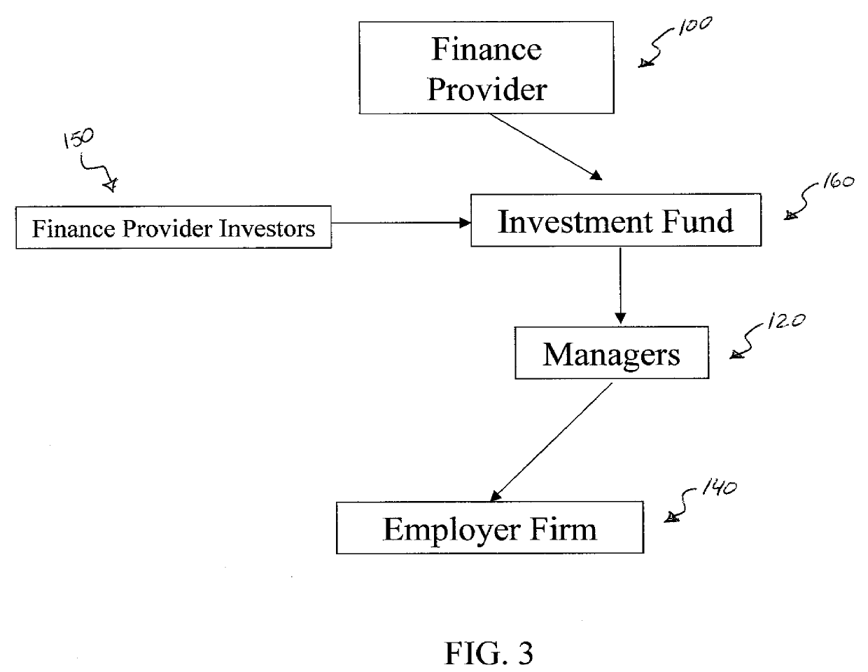

The products systems and methods of the present invention also relate to the structural relationships between the Finance Providers and its investors. For example, as seen in FIG. 3, Finance Provider 100 may be funded by an investment source, or Finance Provider Investors 150. Investors 150 may be comprised of one or more individual investors, banks, or other entities. The investments contributed by Investors 150 to the Finance Provider 100 may be held in an investment fund 160 or other financial or investment vehicle. Finance Provider 100 may then use the invested capital to facilitate a manager's 120 investment in an LBO transaction 140. Alternatively, Investor's 150 funds may be used to secure additional equity, i.e. in the form of a loan, which in turn may be used to finance manager's 120 investment an employer firm 140. One example of the use of Investor's 150 funds to secure financing is the purchase a subordination from a Lender of Record (not shown).

Another example of using Investor's 150 funds would be to use the equity or capital to secure loans made to Finance Provider 100, wherein said loan proceeds are then used to finance loans to managers 120 investing in an underlying investment in an employer firm 140. In this example of the structure of relationships, Finance Providers 100 are able to offer an investment vehicle 160 limited to a particular type of investment, namely loans to managers 140 investing in an underlying investment in an employer firm 140. As will be discussed in more detail below, the characteristics of the financial product offered to management making an underlying investment in an employer firm or related entity provides a unique investment structure for investors in the investment vehicle offered by the Finance Provider. One such advantageous feature readily apparent to those of skilled in the art is the ability of the Finance Provider to leverage Investor capital or equity such that the IRR's of Investor equity invested in the Finance Provider are geared or leveraged and, thus, greater than the IRR's of the managers and/or members in the underlying investment of the employer firm or related entity.

One aspect of the present invention contemplates a primary financial product or PFP that is used to facilitate a qualified individual's participation in an underlying investment in an employer firm or related entity and methods and systems thereof. As contemplated by the present invention, a primary financial product or PFP facilitates investments in employer firm or related entities by qualified individuals by providing a solution to the aforementioned problems associated with a Borrower's participation in said transactions.

One characteristic of the PFP is the facilitation of financing a Borrower's investment in an employer firm for related entity. A characteristic or condition of the PFP involves the association, link, or dependence to a Borrower's upside on the underlying investment. By way of example only, the following discussion assumes the underlying investment is made during a leveraged buyout transaction and that the borrower is investing in the employer firm as an adjunct to employment. As disclosed previously however, the products, systems and methods of the present invention are not limited to leveraged buyout transactions. A Borrower's upside in an LBO occurs at a realization event. A realization event may be a manager's exit from participation in the LBO transaction, the sale of the company formed by the LBO transaction, quarterly or annual non-salary compensation disbursements, or the receipt of any returns related to a Borrower's participation in the LBO transaction. Upon a realization event, the Borrower receives gains related to the underlying investment made by the Borrower in the employer firm or related entity. Because of the nature of LBO and their highly leveraged financings (including the effect of the envy ratio), gains realized by Borrowers in an LBO may be disproportionately higher than the IRR of the new company as a whole.

By sharing, participating, or otherwise associating repayment of the original loan or PFP on the upside realized by a Borrower, increased value or gains may be realized on the PFP than traditional loan or investments products. In one aspect of the present invention, the Financial Provider provides a PFP to a Borrower in which the terms of the PFP include a condition that the Financial Provider is entitled to a percentage of the upside realized by the Borrower upon a realization event. In alternative embodiments, the PFP is a loan product that contains one or more profit components. For example, in one embodiment of the present invention, a PFP is offered to Borrowers that includes a transaction fee paid to the Financial Provider, an interest rate that is applied by conventional methods to the principal loan value of the PFP, and an upside payment component that corresponds, relates, or is dependent on the upside realized by the Borrower on his or her underlying investment in the employer firm. As one of skill in the art would understand, the upside payment component may be a percentage of the upside upon a realization event or some other amount such as a mixture between fixed and sliding percentages of said upside. Because the upside realized by a Borrower is contingent upon a number of factors, the present invention contemplates a variety of fixed or sliding or combinations of fixed and sliding calculation components.

For example, in one embodiment of the PFP, the upside component payment may be tiered to the total returns experienced by a Borrower. In this embodiment of the present invention, the profit component of the PFP may be calculated by using a sliding criteria. Thus, for example, upon a realization event the upside component payment may be calculated as a first percentage with respect to increases in the original Borrower's equity between a first return range plus a second percent applied to increases over and above the upper limit of the first return range. As one of skill in the art would understand, a variety of ranges and percentages could be used to calculate the upside component payment

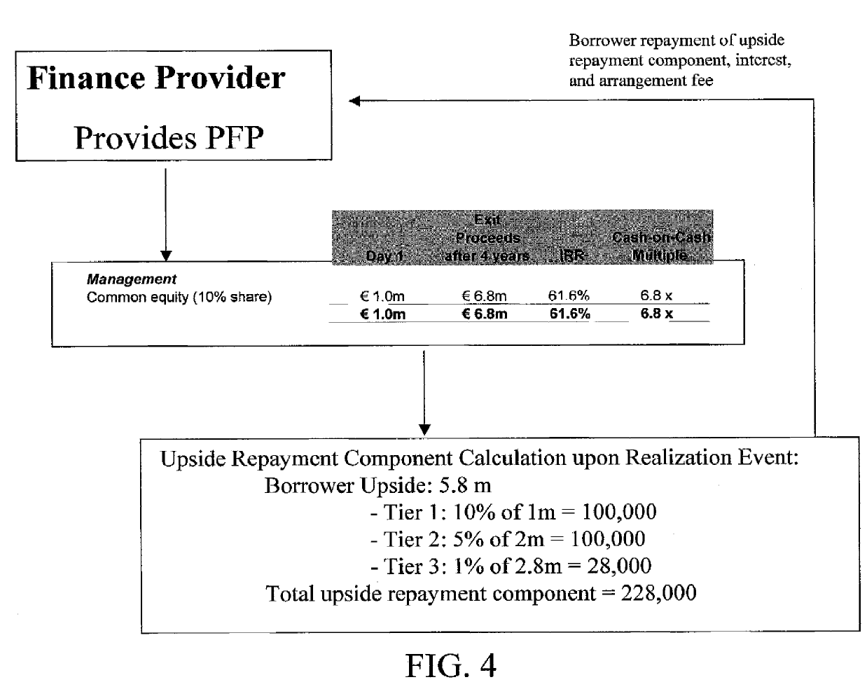

One exemplary, embodiment is illustrated in FIG. 4. As seen in FIG. 4, a Borrower undergoes a realization event in which the original equity contribution to all employer firm or related entity results in an IRR of 61.6%. Upon repayment of the PFP, which was used to finance or facilitate the Borrower's equity contribution, the upside component payment is calculated using a first percentage on upsides of 1 million euros or less, a second percentage on upsides between 1 million and 3 million euros, and a third percentage on upsides over 3 million euros.

In alternative embodiments, the upside component payment may be calculated as a percentage of the upside percentage. For example the PFP may require an upside component payment of a first percentage based on a Borrower's IRR on equity that falls within a second percentage and a upside component payment of a third percentage based on a Borrower's IRR on equity that falls within a fourth percentage. One example would include an upside component payment of 10% on gains realized by the Borrower of between 0 and 30% of the original equity investment in the employer firm and an upside component payment of 5% on gains over 30%.

While any number of different variations and calculation schemes may be used, the particulars of which are not essential to the present invention, the present invention contemplates PFPs that include pre-determined sharing in the upside of a Borrower's equity in an LBO transaction. And while in the preceding examples the PFP takes the form of a direct loan by a Finance Provider to a Borrower (which includes interest rates and arrangement or other transaction fees) the facilitation of a Borrower's participation in an underlying LBO transaction may take other forms. Thus, the PFP may take many forms such that the PFP facilitates the participation of a Borrower in an LBO transaction. The PFP is simply characterized in that repayment of the PFP includes that the Borrower agrees to pay, transfer, or otherwise share a pre-determined proportion of the upside of the underlying equity investment upon a Borrower's realization event.

In some embodiments of the present invention, the PFP may be further characterized as a full or partial recourse loan or obligation. In other words, the Borrower would agree that the loan or obligation provided by the PFP be repaid and that the Finance Provider may seek repayment in full or in part through other assets of the Borrower should a realization event occur that is not able to satisfy the terms and conditions of repayment. In some embodiments, the Finance Provider may secure the PFP with a Borrower's shares in the employer firm or related entity.

In other embodiments of the present invention, the PFP is unsecured. In these embodiments, the loan or other obligation(s) that facilitates the Borrower's underlying, investment in the employer firm or related entity is not secured with the Borrower's collateral or other assets. As one of skill in the art would understand, the PFP may be unsecured and full recourse, or any combination of the two characteristics. As should be readily apparent to one of skill in the art, the IRR of a PFP may be greater than conventional financing alternatives in that the IRR of the PFP is linked to or correlates with the Borrower's IRR on equity in the underlying investment which was made on a price or value privileged basis.

In an alternative embodiment of the present invention, a PFP may be offered to employees or members of a private equity firm or other member of the Financial Sponsors. In many cases, partners of a private equity firm or other member of a Financial Sponsor group may be required to contribute personal funds to invest in the equity component of an underlying transaction or fund respectively sponsored or managed by the Financial Sponsor. In these instances, a PFP may be provided to said individuals to facilitate financing. Much like the terms and conditions associated with the PFPs offered to managers, the PFPs offered to members of private equity firms or other individuals of a Financial Sponsor include repayment terms in which the Borrower agrees to share with the Finance Provider a portion of the upside on the equity portion of the transaction or fund (for example through a share of the carried interest).

The present invention also provides for methods and systems related to the selection, qualification, calculation, valuation, and/or determination of PFPs and their attendant terms. As one of skill in the art would understand, the upside payment component may be determined at the outset by a number of factors and nothing herein should be interpreted to limit the number or type of factors.

Nonetheless, as the quality of employer firms or related entities varies, some qualification criteria may be used to evaluate the worthiness of any particular underlying investment. In an embodiment of the present invention, the system and methods vary the predetermined upside payment component depending on the determined quality of the underlying investment. Accordingly, in an embodiment of the present invention, determinations regarding the PFP may be made based upon reference to transaction specific risk factors. Such factors may include, but are not necessarily limited to loan to value ratio, quality ranking of said Borrower, quality ranking of the employer firm, terms of employment offered to the borrower, including anti-dilution and early termination provisions, current future business environment, expected future business environment, current specific marketplace environment, expected future specific marketplace environment, perceived risk/reward of underlying LBO transaction, and deal structure, including envy ratio, and likely exit arrangements.

Additional transaction specific risk factors may be relevant depending on the particulars of a deal. Further, one, more than one, some, or all of the above listed factors may be used in analyzing proposed deals. In determining the precise conditions attendant to the proposed PFP, one or more conditions may be varied depending on the analysis of the underlying investment as it relates or is scored by the transaction specific risk factors.

Thus for example, in the context of a leveraged buyout, some transactions may be regarded as less risky based on an analysis using certain transaction specific risk parameters. Accordingly, the conditions attendant to the proposed PFP may be more accommodative from the Borrower's perspective. For example, where an underlying LBO transaction is sponsored by a Financial Sponsor with an excellent track record, in an industry sector that is deemed favorable, and/or the loan has a low LTV of, for example, 50% or less, the PFP may condition repayment of the PFP with an upside repayment, component that is smaller than a PFP offered on an investment in which the transaction specific risk factors are less favorable.

As one of skill in the art would understand, the analysis, determination, calculation, or other qualification of the “worthiness” of participating in or offering a PFP to a Borrower in an underlying LBO transaction can be automated and become part of a system, processing machine, computer system, or other automated mechanisms. Further, the system may be designed with additional functionalities including but not limited to tracking performance, reporting performance, identifying potential employer firms or related entities, ranking PFP's, displaying characteristics of outstanding PFP's, etc. In another embodiment of the present invention, a system may be used to determine the appropriateness of offering a PFP and the terms attendant to said PFP. In conjunction with the terms and conditions provided by the system, a loan provider or other user may vary said terms and conditions based on experience or the outcome of negotiations with the Borrower.

Accordingly, in an embodiment of the present invention, a system may first qualify a proposed PFP by examining, scoring, or otherwise rating the proposed Borrower along a set of criteria such as credit profile, etc. Next, a system may value the underlying transaction by examining, scoring, or otherwise rating, criteria associated with valuation including in some embodiments size of the deal, Financial Sponsor track record, industry sector, etc. The system may then use the aforementioned determinations in a calculation step that determines the pricing of the deal, or in other words, the upside repayment component, which as described previously may be a percentage of a Borrower's upside upon a realization event. Thus, in addition to making determinations as to whether a PFP should be offered, the system of an embodiment of the present invention is also able to recommend deal conditions or pricing parameters.

Another aspect of the present invention includes the provision of an investment vehicle or secondary financial product (“SFP”). In this aspect of the present invention, a Finance Provider may also offer an investment vehicle or SFP to investors. Investors may contribute equity as investments in the investment vehicle by which the investors would be allocated a percentage or shares of the investment vehicle or SFP. The proceeds of the investment vehicle may be used to fund, offer, or otherwise provide PFPs and the returns of the SFP are correlated to the returns realized on the underlying PFPs. In this manner an investment vehicle is provided that gives investors access to a Borrower's investment in an underlying investment.

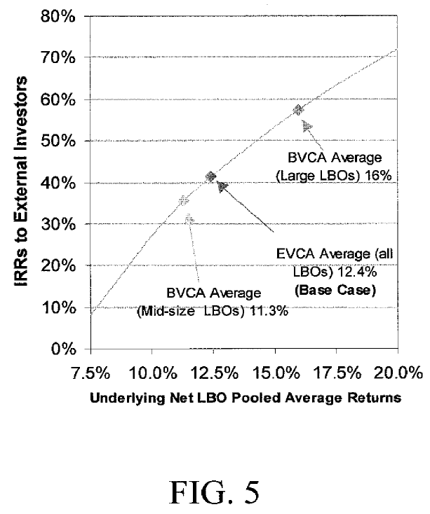

As one of skill in the art would understand, the success or returns of PFPs may vary. The performance of individual employer firms or related entities will differ depending on a number of factors. As an example, leveraged buyout transactions are one type of transaction that allows qualified individuals to participate in investments in an employer firm as an adjunct to employment on a price or value privileged basis. And as seen in FIG. 5, historical performance of LBO transactions average between about 10% and about 70%. To reduce risk, an SFP may be comprised of more than one PFP. Accordingly, the investment vehicle is diversified in the sense that the performance of the investment vehicle over time is dependent on a number of PFPs rather than a single PFP.

In this manner, individual investors, mutual funds, banks, private equity firms, or other investment groups have access to a diversified investment vehicle that relates or tracks performance of select PFPs. In this embodiment of the present invention, the IRRs of PFPs are provided to investors in the form of an SFP.

As one of skill in the art would understand, any number of methods or systems may be used in constructing a portfolio or investment vehicle of PFPs. In one embodiment of the present invention, determinations of the PFPs offered to Borrowers which form the SFP are made according to set criteria. In an embodiment of the present invention, the SFP comprises all PFPs made by a Finance Provider. In other embodiments, the SFP comprises some of the PFPs made by a Finance Provider.

Systems and methods used to determine the PFPs that form an SFP may vary, but in at least an embodiment of the present invention, the SFP is determined in relation to various parameters including the identity of the Financial Sponsors to the underlying investment, industry sector, country of domicile of the employer firm or related entity, aggregate loans per deal, loans per individual, investment objective, deal pricing and other relevant criteria.

Thus in an exemplary embodiment, an SFP may be comprised of a number of PFPs that were qualified and deemed appropriate to the SFP's objective. Where a PFP is tied to an employer firm or related entity in which the Financial Sponsors have a strong successful track record, the PFP may be deemed worthy of inclusion in an SFP. Where a PFP is part of an underlying employer firm or related entity in an industry sector that is unfavorable given current market conditions, the PFP may be deemed inappropriate for inclusion in an SFP. As one of skill in the art would understand, scoring or other matrix like determinations may be made with respect to the various characteristics of a PFP for determinations as to the inclusion or exclusion from an SFP. In these instances, SFP's may be formed with particular objectives in mind, such as exposure to certain industries, aggressive or high risk SFPs, etc.

The systems that are used by the various aspects of the invention, or portions of such systems, may be in the form of a “processing machine,” such as a general purpose computer for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including a microcomputer, minicomputer or mainframe for example, a programmed microprocessor, a microcontroller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the process of the invention.

It is appreciated that in order to practice the method of the invention as described above, it is not necessary that the processors and/or the memories of the processing machine be physically located in the same geographical place. That is, each of the processors and the memories used in the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example the software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further the data that is processed by the set of instructions might also be contained on any of a wide variety of media or medium. That is, the particular medium i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory, or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

While the invention herein disclosed has been described by means of specific embodiments and applications thereof, numerous modifications and variations can be made thereto by those skilled in the art without departing from the scope of the invention as set forth in the claims.

### EXAMPLE 1

The following example illustrates the typical allocation of equity and loan components by financial sponsors and management. As one of skill in the art would understand, the financial sponsors in this example can represent one or more firms, funds or individuals such as private equity firms or funds, banks, or other investors. Management in this example can be managers of the newly formed company or a related entity and are also referred to as Borrowers.

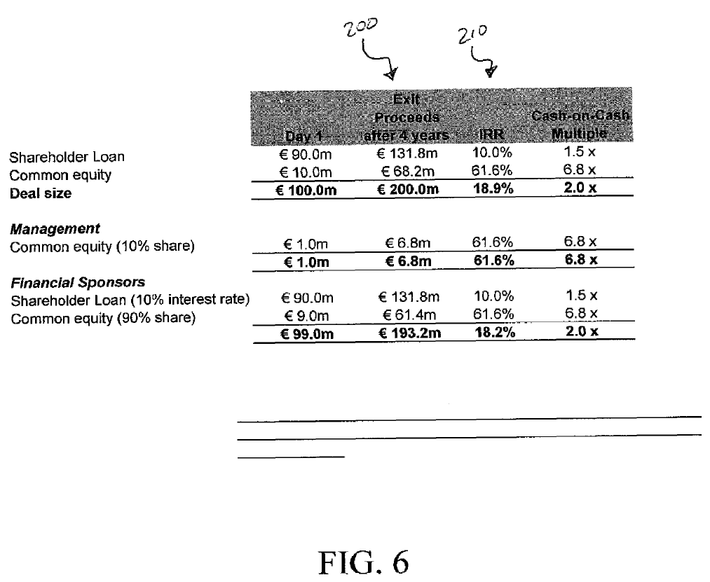

For illustrative purposes only the following discussion relates to an employer firm and participation in an underlying investment by a qualified individual as an adjunct to employment in the employer firm on a price or value privileged basis in the context of a leveraged buyout transaction. Thus, for purposes of this example the deal size or overall value of a leveraged buyout transaction may be 400 million euros or more. In this exemplary deal size, a portion, for example 75%, of the purchase price may be provided by outside lending institutions or other third party financial entities. The remaining purchase price is provided by Financial Sponsors and Management. Thus, as seen in FIG. 6, the equity contributions of Financial Sponsors and Management is shown.

With reference to FIG. 6, Financial Sponsors and Management contribute 100 million euros to the overall LBO transaction price. Typically, Financial Sponsors contribute the vast majority of this portion of the deal, as is shown in this example wherein the Financial Sponsors provide 99 million euros to the transaction. As seen in FI(G. 6, managers provide 1 million euros.

As further seen in FIG. 6, the contribution of Financial Sponsors is comprised of both an equity and loan component. Thus, as seen in this example, 90% of the Financial Sponsor's investment in the LBO transaction is financed by a shareholder loan component and 10% of the investment is in equity. As further seen in FIG. 6, management contributes 1 million euros of equity, which is shown as the management equity contribution.

By way of example, a doubling in value is assumed for the new company after four years time as seen in FIG. 6. This is seen in exit proceed column 200. Returns for each component of the financed transaction is shown in the IRR column 210.

Thus, this example illustrates the increased gearing or leveraging of returns on equity using highly leveraged financing. This example further illustrates the increased returns available to managers and members by participating in the equity financing of a leveraged buyout transaction. As seen in FIG. 6, management's upside in this example is 5.8 million euros, which amounts to an IRR of 61.6%. Because the returns on management investments are limited to the equity component of the transaction, IRRs are greater for management than the financial sponsors, which include a shareholder loan component that may be paid at fixed interest rates.

### EXAMPLE 2

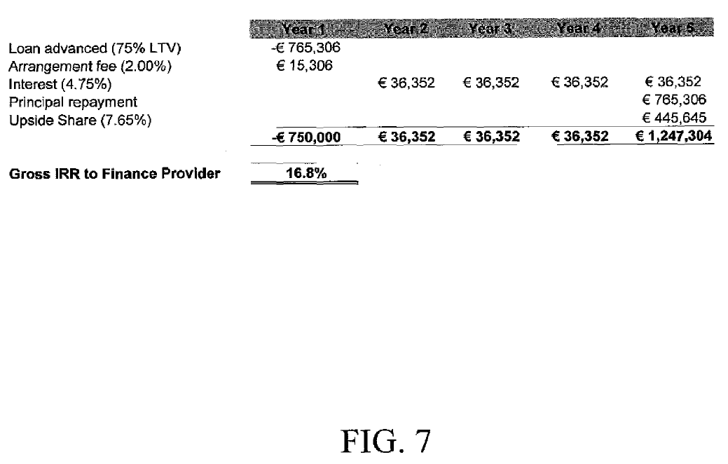

The following example illustrates one aspect of the present invention as it relates to the PFP and the potential gains that can be realized on a PFP. As seen in FIG. 7, and with continuing reference to FIG. 6, an exemplary PFP to a Borrower is shown that represents 75%, LTV to a Borrowers required 1 million euros equity contribution in an underlying investment. As seen in FIG. 7 an arrangement fee component of 2% is charged and the principal amount of the PFP is subject to a 4.75% interest rate. As one of skill in the art would understand the present invention is not limited to the inclusion of an arrangement fee or interest rate. Additionally, the percentages charged to a Borrower, if any, may vary according to market rates or other financial considerations. As seen in FIG. 7, the upside component payment is set at 7.65%. As discussed previously this component may vary and may be comprised of a number of tiers or graduated percentages. With continuing reference to FIG. 7, upon a realization event in year five, an IRR on the PFP of 16.8% is achieved wherein the original or underlying LBO transaction returns two times the original investment. As seen with respect to Example 1, the IRR of the PFP is comparable to the IRR of the Financial Sponsors on the overall IRR. The IRR of the PFP is also much greater than traditional loan products or other finance facilitating arrangements.

### EXAMPLE 3

The following example illustrates one aspect of the present invention as it relates to a SFP. An SFP may be offered to individual investors. The SFP may be marketed as a fund or other investment vehicle whose primary investments will be the provision of financing to managers participating in LBO transactions wherein the repayment of the financing provided includes a share in the manager's upside in the underlying LBO transaction. In this example, the fund will hold issue or otherwise be comprised of one or more PFPs. The SFP will be offered to investors and the return of the investors investments will track or correlate with the one or more PFPs in this example, the SFP may require a minimum contribution and be subject to management fees or other account maintenance fees.

While various embodiments of the present invention have been described above, it should be understood that they have been presented by way of example only, and are not all inclusive. Thus, the breadth and scope of the present invention should not be limited by any of the above-described exemplary embodiments, but should be defined only in accordance with the following claims and their equivalents.

What is claimed is:

1. A primary financial product comprising a loan, wherein said primary financial product provides a borrower with access to participation in an investment on a price and/or value privileged basis, wherein said primary financial product is characterized by at least two conditions, said conditions being
a) that the primary financial product is offered or otherwise provided by a finance provider to a borrower, wherein proceeds of said product are used to fund investment in an underlying investment, said investment being made by the borrower in an employer firm or related entity as an adjunct to employment; and
b) repayment of the primary financial product to the finance provider includes the return of principal borrowed and a share in the borrower's upside in said underlying investment or investments, said share being substantially fixed at the inception of the loan.

2. The primary financial product of claim 1, wherein said primary financial product is further characterized in that the loan is full or partial recourse to other assets of the Borrower.

3. The primary financial product of claim 1, wherein said primary financial product is further characterized in that the loan is without recourse.

4. The primary financial product of claim 2, wherein said primary financial product is secured only by a borrower's underlying investment in the employer firm or related entity.

5. The primary financial product of claim 1, wherein said repayment comprises a repayment of principal and a pre-determined upside payment component.

6. The primary financial product of claim 5, wherein said upside payment component is a percentage of the upside realized by a borrower upon a realization event.

7. The primary financial product of claim 6, wherein said upside payment component is determined by applying more than one percentage number to different ranges of a borrower's realized upside.

8. A method of facilitating a borrower's participation in an underlying investment in an employer firm or related enity wherein said participation occurs as an adjunct to employment, said method comprising, offering one or more borrowers a primary financial product that conditions repayment of the primary financial product on the return of principal and payment of a share of the borrower's upside in the underlying investment, said payment of a share of the borrower's upside being substantially fixed at the inception of the primary financial product.

9. The method of claim 8, wherein said primary financial product comprises a loan.

10. The method of claim 9, wherein said primary financial product is further characterized in that the loan is full or partial recourse to other assets of the Borrower.

11. The method of claim 10, wherein said primary financial product is further characterized in that the loan is without recourse.

12. The method of claim 10, wherein said primary financial product is secured only by a borrower's underlying investment in the employer firm.

13. The method of claim 8, including the step of identifying borrowers participating in underlying investments in employer firms.

14. The method of claim 8, including the step of qualifying said borrowers using transaction specific risk factors.

15. The method of claim 14, wherein said transaction specific risk factors include at least one of a loan to value ratio, quality ranking of said borrower, quality ranking of the employer firm or related entity, terms of employment offered to the borrower, rankings related to anti-dilution provisions, current future business environment, expected future business environment, current specific marketplace environment, expected future specific marketplace environment, perceived risk/reward of the underlying investment, and deal structure.

16. The method of claim 15, wherein said upside payment component is a pre-determined percentage of the upside realized by the borrower on the underlying investment.

17. The method of claim 16, wherein said percentage is determined by an analysis of transaction specific risk factors.

18. The method of claim 16, wherein said percentage is adjusted based on negotiations with the borrower and the judgment of the loan provider.

19. A system for offering a primary financial product comprising,
A computer system configured with at least one database, at least one client workstation, and programmable instructions, said system configured to execute a qualification step, valuation step, and calculation step, wherein said system is used to determine the availability and terms of said primary financial product to a borrower, said borrower investing in an underlying investment with an employer firm or related entity as an adjunct to employment, wherein said primary financial product comprises an upside repayment component, said upside repayment component reflecting payment of a percentage of the borrower's upside in the underlying investment upon realization,
the system further configured to perform said qualification step, valuation step, and calculation step as a result of user input, said user input relating to a the underlying investment or borrower data,
the system further configured to modify the upside repayment component percentage based on one or more transaction specific risk factors.

20. The system of claim 19, wherein said transaction specific risk factor is selected from a group consisting of a loan to value ratio, quality ranking of said borrower, quality ranking of the employer firm or related entity, terms of employment offered to the borrower, rankings related to anti-dilution provisions, current future business environment, expected future business environment, current specific marketplace environment, expected future specific marketplace environment, perceived risk/reward of underlying investment, and deal structure.

21. The system of claim 20, wherein said qualification step analyses the appropriateness of offering the primary financial product to a borrower.

22. The system of claim 20, wherein said valuation step analyses the expected return of the underlying investment in the employer firm or related entity.

23. The system of claim 20, wherein said calculation step determines one or more percentages applied to the borrower's upside in the underlying investment upon a realization event.

24. The system of claim 19, wherein the primary financial product comprises a loan.

25. The system of claim 19, wherein the upside component payment is substantially fixed at inception of the loan.
